(19) United States
(12) Patent Application Publication
(10) Pub. No.: US 2025/0308406 A1
(43) Pub. Date: Oct. 2, 2025

(54) DRIVING-BEHAVIOR EVALUATION SYSTEM, DRIVING-BEHAVIOR EVALUATION METHOD, AND STORAGE MEDIUM

(71) Applicant: HONDA MOTOR CO., LTD., Tokyo (JP)

(72) Inventor: Kazuasa Suzuki, Wako-shi (JP)

(21) Appl. No.: 19/064,924

(22) Filed: Feb. 27, 2025

(30) Foreign Application Priority Data
Mar. 27, 2024 (JP) 2024-050803

(51) Int. Cl. G09B 19/14; G06F 8/65; G07C 5/00; G07C 5/04; G09B 19/16

(52) U.S. Cl. CPC G09B 19/14; G07C 5/008; G07C 5/04; G09B 19/167; G06F 8/65

(57) ABSTRACT

A driving-behavior evaluation system includes an external-environment-information acquisition unit, a traveling-information acquisition unit, and a processor. The processor is configured to execute a program and thereby evaluate driving behavior of a driver of a vehicle based on information acquired by the external-environment-information acquisition unit and the traveling-information acquisition unit. The processor is configured to receive a request for a driving evaluation item of evaluating the driving behavior; set a training-target-area candidate for a traveling-target area for training based on the driving evaluation item and a movement history of a driver of the vehicle; and identify a training-target area, for which training is requested, from the set training-target-area candidates based on the driving evaluation item received by the processor.

### CROSS-REFERENCE TO RELATED APPLICATION

Priority is claimed on Japanese Patent Application No. 2024-050803, filed Mar. 27, 2024, the content of which is incorporated herein by reference.

### BACKGROUND OF THE INVENTION

### Field of the Invention

The present invention relates to a driving-behavior evaluation system, a driving-behavior evaluation method, and a storage medium.

### Description of Related Art

In recent years, research and development has been conducted to acquire data and the like related to a user's driving behavior and offer aid. Regarding a user's driving behavior, conventionally, a safe driving evaluation system is known as a system for evaluating a driver's safe driving (for example, refer to Japanese Unexamined Patent Application, First Publication No. 2010-107385). In the conventional safe driving evaluation system, for example, a driver's safe driving is evaluated by comparing traveling data related to a brake operation of a vehicle with a threshold set for the traveling data.

Incidentally, in technology related to training or assisting human motion, safe driving is evaluated when a vehicle travels within a range set in advance in the foregoing conventional safe driving evaluation system. For this reason, if a user desires to be evaluated for a particular item, the area where a vehicle is traveling may not be within a range suitable for evaluation, and therefore it is sometimes difficult to perform appropriate evaluation.

The invention has been made in consideration of such circumstances, and an object thereof is to evaluate driving by traveling in an area suitable for evaluation. Further, this will ultimately contribute to optimizing driving behavior.

### SUMMARY OF THE INVENTION

A driving-behavior evaluation system, a driving-behavior evaluation method, and a storage medium according to the invention employ the following constitutions.
(1): A driving-behavior evaluation system according to one aspect of the invention includes: an external-environment-information acquisition unit configured to acquire external environment information, the external environment information being related to a circumference environment around a vehicle; a traveling-information acquisition unit configured to acquire traveling information, the traveling information being related to traveling of the vehicle; and a processor configured to execute a program and thereby evaluate driving behavior of a driver of the vehicle based on the external environment information acquired by the external-environment-information acquisition unit and the traveling information acquired by the traveling-information acquisition unit. The processor is configured to: receive a request for a driving evaluation item of evaluating the driving behavior; set a training-target-area candidate for a traveling-target area for training based on the driving evaluation item and a movement history of a driver of the vehicle; and identify a training-target area, for which training is requested, from the set training-target-area candidates based on the driving evaluation item received by the processor.
(2): According to the aspect of the foregoing (1), when there is a problem related to the driving evaluation item received by the processor regarding the vehicle traveling in the training-target area, the processor issues a notification related to the problem, and when there is a problem related to an item other than the driving evaluation item received by the processor, the processor does not issue a notification related to the problem.
(3): According to the aspect of the foregoing (1), the driving-behavior evaluation system further includes a display unit configured to display a map including a circumference environment around the vehicle. The display unit displays the identified training-target area and the driving evaluation item for which a request has been received by the processor.
(4): According to the aspect of the foregoing (1), the processor is configured to identify the driving evaluation item based on the driving evaluation item received by the processor and external environment information acquired within the set training-target-area candidate.
(5): According to the aspect of the foregoing (3), the display unit includes at least one of an in-vehicle instrument mounted in the vehicle and an information terminal device carried by an occupant of the vehicle.
(6): According to the aspect of the foregoing (1), the processor is provided in an external server outside the vehicle.
(7): According to the aspect of the foregoing (6), the external server is configured to: communicate with at least one of a different vehicle other than the vehicle and a transportation infrastructure facility related to transportation infrastructure in addition to the vehicle; and update the external environment information based on at least one of traveling information on the different vehicle and information related to the transportation infrastructure provided by the different vehicle and the transportation infrastructure facility.
(8): According to the aspect of the foregoing (1), the processor is configured to acquire circumference information obtained from other traffic participants around the vehicle. The processor is configured to evaluate driving behavior of a driver of the vehicle further based on the circumference information.
(9): According to the aspect of the foregoing (1), the processor is configured to acquire an updating program of updating the program. The program is updated by the updating program acquired by the processor. The processor is configured to update the program upon approval by an authority related to the vehicle.
(10): According to the aspect of the foregoing (1), the processor is configured to suggest provision of a predetermined service to the driver based on results of evaluation of driving behavior from the processor and a usage history of the processor.
(11): According to the aspect of the foregoing (6), the external server is configured to manage registered-user information related to a registered user, the registered user is capable of using the vehicle. The processor is configured to authenticate whether a driver entering the vehicle is the registered user. The processor is configured to evaluate driving behavior of the driver of the vehicle when the driver is authenticated as the registered user.
(12): A driving-behavior evaluation method according to one aspect of the invention is a driving-behavior evaluation method causing a computer to: acquire external environment information, the external environment information being related to a circumference environment around a vehicle; acquire traveling information, the traveling information being related to traveling of the vehicle; and evaluate driving behavior of a driver of the vehicle based on the external environment information and the traveling information which have been acquired. The computer receives a request for a driving evaluation item of evaluating the driving behavior, sets a training-target-area candidate for a traveling-target area for training based on the driving evaluation item and a movement history of a driver of the vehicle, and identifies a training-target area, for which training is requested, from the set training-target-area candidates based on the received driving evaluation item.
(13): A storage medium according to one aspect of the invention is a computer-readable non-transitory storage medium storing a program. The program causes a computer to: acquire external environment information, the external environment information being related to a circumference environment around a vehicle; acquire traveling information, the traveling information being related to traveling of the vehicle; and evaluate driving behavior of a driver of the vehicle based on the external environment information and the traveling information which have been acquired. The computer receives a request for a driving evaluation item of evaluating the driving behavior, sets a training-target-area candidate for a traveling-target area for training based on the driving evaluation item and a movement history of a driver of the vehicle, and identifies a training-target area, for which training is requested, from the set training-target-area candidates based on the received driving evaluation item.

According to the aspects of (1) to (13), it is possible to evaluate driving by traveling in an area suitable for evaluation.

### BRIEF DESCRIPTION OF THE DRAWINGS

FIG. 1 is a view showing an example of a constitution of a driving-behavior evaluation system 1 of a first embodiment.

FIG. 2 is a flowchart showing an example of processing in a driving evaluation unit 30 of the first embodiment.

FIG. 3 is a view showing an example of a training-target-area candidate 53 on a map.

FIG. 4 is a view showing an example of a comparison training-target-area candidate α.

FIG. 5 is a flowchart showing another example of processing in the driving evaluation unit 30 of the first embodiment.

FIG. 6 is a view showing an example of a constitution of a driving-behavior evaluation system 2 of a second embodiment.

### DETAILED DESCRIPTION OF THE INVENTION

Hereinafter, with reference to the drawings, an embodiment of a driving-behavior evaluation system, a driving-behavior evaluation method, and a storage medium of the invention will be described.

### First Embodiment

A driving-behavior evaluation system 1 of a first embodiment evaluates driving behavior of a driver when the driver undergoes driving training. When evaluating the driving behavior of a driver, the driving-behavior evaluation system 1 identifies a training-target area where the driver will undergo driving training. The driving-behavior evaluation system 1 identifies a plurality of training-target-area candidates before a driver undergoes driving training. A trainee undergoing driving training selects and designates a training-target area from among the plurality of training-target-area candidates and undergoes driving training.

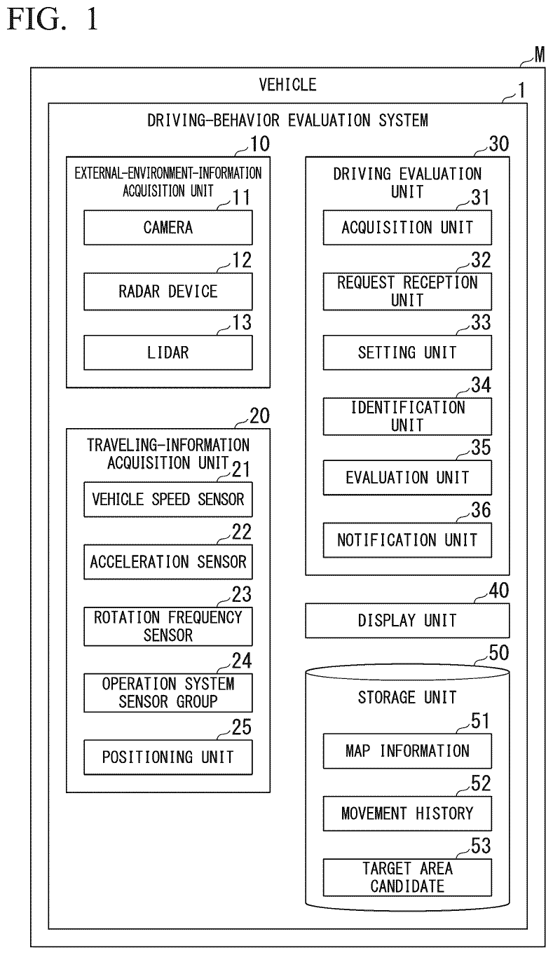

FIG. 1 is a view showing an example of a constitution of the driving-behavior evaluation system 1 of the first embodiment. For example, the driving-behavior evaluation system 1 of the first embodiment includes an external-environment-information acquisition unit 10, a traveling-information acquisition unit 20, a driving evaluation unit 30, a display unit 40, and a storage unit 50. For example, the driving-behavior evaluation system 1 is mounted in a vehicle M.

The external-environment-information acquisition unit 10 detects and acquires external environment information. The external environment information is information related to the circumference environment around the vehicle M. For example, the external-environment-information acquisition unit 10 includes a camera 11, a radar device 12, and a LIDAR 13. For example, the camera 11 is a digital camera using a solid-state image capturing element such as a charge coupled device (CCD) or a complementary metal oxide semiconductor (CMOS). The camera 11 is attached to an optionally selected location in the vehicle M in which the driving-behavior evaluation system 1 is mounted. When images on the side in front are captured, the camera 11 is attached to an upper part of a front windshield, a rear surface of a rearview mirror, or the like. For example, the camera 11 captures images around the vehicle M periodically and repeatedly. The camera 11 may be a stereo camera.

The radar device 12 radiates radio waves such as millimeter waves around the vehicle M and detects at least the position (distance and azimuth) of an object by detecting radio waves (reflected waves) reflected by the object. The radar device 12 is attached to an optionally selected location in the vehicle M. The radar device 12 may detect the position and the speed of an object by a frequency modulated continuous wave (FM-CW) method.

The LIDAR 13 emits light (or electromagnetic waves having wavelengths close to that of light) around the vehicle M and measures scattered light. The LIDAR 13 detects the distance to a target based on the time from light emission to light reception. For example, emitted light is pulsed laser light. The LIDAR 13 is attached to an optionally selected location in the vehicle M. Images captured by the camera 11, positions of objects detected by the radar device 12, and distances to targets detected by the LIDAR 13 are examples of external environment information.

The traveling-information acquisition unit 20 detects and acquires traveling information. The traveling information is information related to traveling of the vehicle M. For example, the traveling-information acquisition unit 20 includes a vehicle speed sensor 21, an acceleration sensor 22, a rotation frequency sensor 23, an operation system sensor group 24, and a positioning unit 25. The vehicle speed sensor 21 detects the speed of the vehicle M. The acceleration sensor 22 detects the acceleration of the vehicle M. The rotation frequency sensor 23 detects the rotation frequency of wheels provided in the vehicle M.

The operation system sensor group 24 has operation amount detection sensors detecting the total amount of operation of an accelerator pedal, a brake pedal, and a steering wheel. For example, the positioning unit 25 includes a global navigation satellite system (GNSS) receiver. The GNSS receiver identifies the position of the vehicle M based on a signal received from a GNSS satellite. The position of the vehicle M may be obtained by a supplementary navigation system (INS). The positioning unit 25 may also be an INS. Detection results of the vehicle speed sensor 21, the acceleration sensor 22, the rotation frequency sensor 23, the operation system sensor group 24, and the positioning unit 25 are examples of traveling information.

The driving evaluation unit 30 evaluates the driving behavior of a driver driving the vehicle M. The driving evaluation unit 30 evaluates the driving behavior of a driver related to a driving evaluation item requested from a driver. When it is evaluated that there is a problem in driver's driving, for example, driving corresponding to a traffic violation has been performed as a result of evaluation, the driving evaluation unit 30 issues a notification related to the problem as necessary. The driving evaluation item is an item of evaluation related to driving of the vehicle and examples thereof include “failure to stop at a stop sign”, “speeding”, “running a red light”, and “driving slowly”. A problem may be a problem related to laws or may be a problem related to driving operations (for example, excessively stepping on the brake, low frequency of use of engine brake, and late timing of turning on headlights).

For example, the driving evaluation unit 30 includes an acquisition unit 31, a request reception unit 32, a setting unit 33, an identification unit 34, an evaluation unit 35, and a notification unit 36. For example, these constituent elements are realized by a hardware processor such as a central processing unit (CPU) executing a program (software). Some or all of these constituent elements may be realized by hardware (circuit; including circuitry) such as a large scale integration (LSI), an application specific integrated circuit (ASIC), a field-programmable gate array (FPGA), or a graphics processing unit (GPU), or may be realized by software and hardware in cooperation. The program may be stored in a storage device such as a hard disk drive (HDD) or a flash memory (a storage device including a non-transitory storage medium) in advance or may be stored in an attachable/detachable storage medium such as a DVD or a CD-ROM (non-transitory storage medium) such that the program is installed when the storage medium is mounted in a drive device.

The acquisition unit 31 acquires external environment information transmitted from the external-environment-information acquisition unit 10, traveling information transmitted from the traveling-information acquisition unit 20, and map information 51 and a movement history 52 stored in the storage unit 50. The acquisition unit 31 updates the movement history 52 and stores it in the storage unit 50 based on the acquired external environment information and traveling information.

For example, the movement history 52 include a route (road) along which the vehicle M has traveled, a time, external environment information and traveling information during traveling, and the like in association with each other. The route along which the vehicle M has traveled may be a traveling path that a driver is familiar with or a route that the driver has traveled to identify a training-target area. For example, the movement history 52 includes information on road signs acquired as the external environment information, driver's driving responding to the road signs (for example, the presence or absence of stopping at stop signs and speeding), and the like.

The request reception unit 32 receives a request from a driver to start training and a driving evaluation item for which the driver desires to be evaluated during training (hereinafter, a desired evaluation item). For example, a driver transmits a request to start training to the driving evaluation unit 30 by operating a terminal device carried by the driver, an input device provided in the vehicle M, or the like. For example, the input device may be a button provided in the steering wheel or an instrument panel, or may also be a graphical user interface (GUI) when the display unit 40 is a touch panel. A request to start training or for the desired evaluation item may be transmitted by someone other than a driver, for example, a passenger or an owner of the vehicle M.

The setting unit 33 sets a training-target-area candidate 53 that is a candidate for a traveling area (training target) for each driving evaluation item from the area shown in the map included in the map information 51 based on the movement history 52 stored in the storage unit 50. Since the movement history 52 includes the external environment information and the traveling information, the setting unit 33 sets the training-target-area candidate 53 further based on the external environment information and the traveling information.

The identification unit 34 identifies a training-target area, for which training is requested, from the training-target-area candidate 53 set by the setting unit 33 based on the desired evaluation item received by the request reception unit 32. For example, when a request to start training is received by the request reception unit 32, the identification unit 34 presents the training-target-area candidate 53 corresponding to the desired evaluation item to a driver.

For example, the identification unit 34 presents the training-target-area candidates 53 to a driver by displaying them on the display unit 40. The driver operates the input device or the like to select a training-target area, in which he/she desires to train (hereinafter, a desired target area), from among the presented training-target-area candidates 53. The input device transmits selection information corresponding to the operation of the driver to the driving evaluation unit 30.

The identification unit 34 acquires the selection information transmitted using the input device. The identification unit 34 identifies the training-target area based on the acquired selection information. Instead of or in addition to the form of selecting a training-target area from among a plurality of training-target-area candidates 53, the identification unit 34 may change the range of the training-target-area candidate 53 and set it as the training-target area. For example, the range of the training-target-area candidate 53 may be changed on the touch panel by a driver moving a line indicating the training-target-area candidate 53 displayed on the touch panel.

The identification unit 34 identifies the driving evaluation item that will become an evaluation target based on the desired evaluation item received by the request reception unit 32. The identification unit 34 may apply the desired evaluation item as the driving evaluation item without any change or may determine the driving evaluation item based on the desired evaluation item and the external environment information on the training-target-area candidate 53. For example, in a case in which the desired evaluation item is “vehicle speed”, when there is external environment information related to the vehicle speed, for example, a sign or a road marking of speed limit within the training-target-area candidate 53, the driving evaluation item may be “vehicle speed”.

The evaluation unit 35 evaluates the driving behavior of a driver based on the external environment information and the traveling information acquired when the vehicle M travels in the identified training-target area. For example, the evaluation unit 35 evaluates the driving behavior of a driver based on the behavior of the vehicle M (for example, the distance to the position of a stop sign or the speed of the vehicle) and the magnitude of the operation of a driver exceeds a predetermined threshold.

For example, there is a case in which the driving evaluation item is “vehicle speed” and in which the external environment information related to the vehicle speed within the desired target area includes a sign or a road marking of speed limit. In this case, the evaluation unit 35 may evaluate driving by comparing the vehicle speed on the sign or the road surface display with the vehicle speed acquired as the traveling information. In this case, acceptability of a user with respect to driving evaluation can be improved.

The notification unit 36 notifies an occupant of evaluation results of the evaluation unit 35 by causing the display unit 40 to display it, for example. When there is a problem related to the desired evaluation item, the notification unit 36 issues a notification related to the problem in the vehicle M traveling in the training-target area. When there is a problem related to a driving evaluation item other than the desired evaluation item, the notification unit 36 does not issue a notification related to the problem. For example, a problem in this case is a violation corresponding to the driving evaluation item. For example, when the driving evaluation item is “stop sign”, it is a failure to stop at a stop sign, and when the driving evaluation item is “speeding”, it is exceeding the speed limit.

The display unit 40 is a part of in-vehicle instruments mounted in the vehicle M and displays various information. For example, the display unit 40 includes a CRT, a display, a touch panel, and the like. For example, the display unit 40 displays a map including the circumference environment around the vehicle M. For example, the display unit 40 displays driving evaluation results notified by the notification unit 36 of the driving evaluation unit 30. After a training-target area is identified, the display unit 40 displays the training-target area identified by the identification unit 34, and the driving evaluation item for which a request has been received by the request reception unit 32.

For example, the storage unit 50 is constituted of a hard disk drive (HDD), a flash memory, or the like. For example, the storage unit 50 stores the map information 51, the movement history 52, and the training-target-area candidate 53. The map information 51 is information on a map of a region including the range in which the vehicle M travels. For example, the map information 51 includes information on traffic lights, signs, buildings standing along the sides of roads, and the like, in addition to information on the roads. For example, information on roads includes information on road widths, traffic directions (one-way traffic or two-way traffic), and the like. For example, the map information 51 is updated and stored when updated map information is transmitted from a map provider or the like that is in business of updating and providing maps.

For example, the movement history 52 is updated by the acquisition unit 31 every time the vehicle M travels and the external-environment-information acquisition unit 10 and the external environment information and the traveling information are transmitted from the traveling-information acquisition unit 20 and acquired by the acquisition unit 31. For example, the acquisition unit 31 may update the external environment information and the traveling information included in the movement history 52 stored in the storage unit 50 when an instruction to update the external environment information and the traveling information is executed. For example, an execution instruction may be transmitted using the input device or the terminal device carried by a driver.

The training-target-area candidate 53 is set by the setting unit 33. The storage unit 50 stores a plurality of training-target-area candidates 53. For example, the training-target-area candidates 53 are sorted for each driving evaluation item. The plurality of training-target-area candidates 53 are set for each driving evaluation item. There may be a single training-target-area candidate 53. When the plurality of training-target-area candidates 53 are set for each driving evaluation item, the driving evaluation item may span a plurality of candidates.

Next, processing in the driving-behavior evaluation system 1 of the first embodiment will be described. In the driving-behavior evaluation system 1 of the first embodiment, the external-environment-information acquisition unit 10 and the traveling-information acquisition unit 20 acquire the external environment information and the traveling information when the vehicle M travels and transmit them to the driving evaluation unit 30 regardless whether or not training is being performed. The driving evaluation unit 30 often updates the movement history 52 stored in the storage unit 50 based on the external environment information and the traveling information which have been transmitted.

For example, when the movement history 52 is updated, the driving-behavior evaluation system 1 causes the setting unit 33 to set the training-target-area candidate 53. For example, the driving-behavior evaluation system 1 starts driver's training when the request reception unit 32 has received a request to start training and the desired evaluation item transmitted in response to the operation of a driver. For example, a request to start training and the desired evaluation item are transmitted using the terminal device carried by a driver, the input device provided in the vehicle M, or the like. A request to start training and the desired evaluation item may be transmitted by someone other than a driver, for example, a passenger or an owner of the vehicle M.

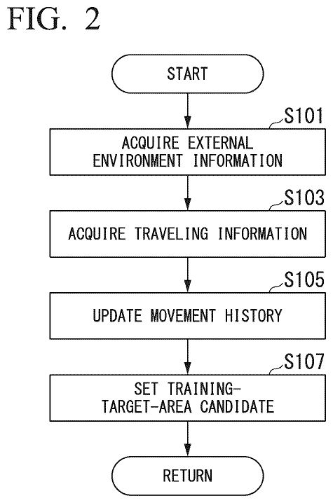

Hereinafter, processing of the driving evaluation unit 30 in the driving-behavior evaluation system 1 when the training-target-area candidate 53 is set will be described first with reference to FIG. 2. FIG. 2 is a flowchart showing an example of processing in the driving evaluation unit 30 of the first embodiment. FIG. 2 shows processing when the training-target-area candidate 53 is set.

In the driving-behavior evaluation system 1, the driving evaluation unit 30 first acquires, in the acquisition unit 31, the external environment information transmitted from the external-environment-information acquisition unit 10 (Step S101). Subsequently, the acquisition unit 31 acquires the traveling information transmitted from the traveling-information acquisition unit 20 (Step S103). The acquisition unit 31 updates the movement history 52 stored in the storage unit 50 based on the external environment information and the traveling information which have been acquired (Step S105). The acquisition unit 31 updates the movement history 52 including the external environment information and the traveling information which have been acquired.

Subsequently, the setting unit 33 sets the training-target-area candidate 53 (Step S107). For example, the setting unit 33 extracts the route along which the vehicle M has traveled based on the updated movement history 52, and when there is any route along which the vehicle M has newly traveled, an area including the route is set as the training-target-area candidate 53. A driving evaluation item is associated with the training-target-area candidate 53 based on signs and the like included in the route. With this, the driving evaluation unit 30 ends the processing shown in FIG. 2.

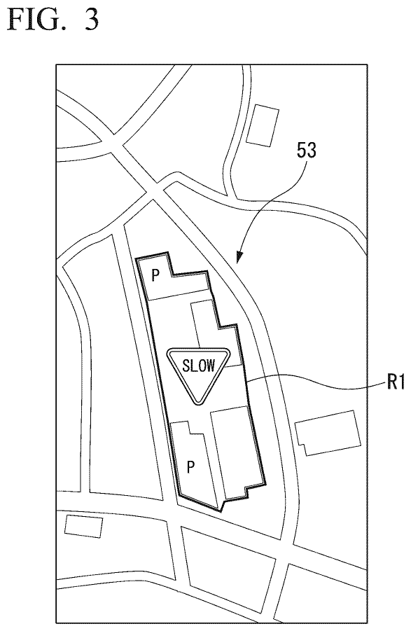

FIG. 3 is a view showing an example of the training-target-area candidate 53 on a map. The map shown in FIG. 3 includes information related to the circumference environment around the vehicle M. For example, the training-target-area candidate 53 is formed by connecting a traveling path R1 along which the vehicle has actually traveled. In this example, “slow driving” is associated as the driving evaluation item. For example, it is conceivable that the training-target-area candidate 53 be set by connecting arbitrary points on a wide road such as a main road.

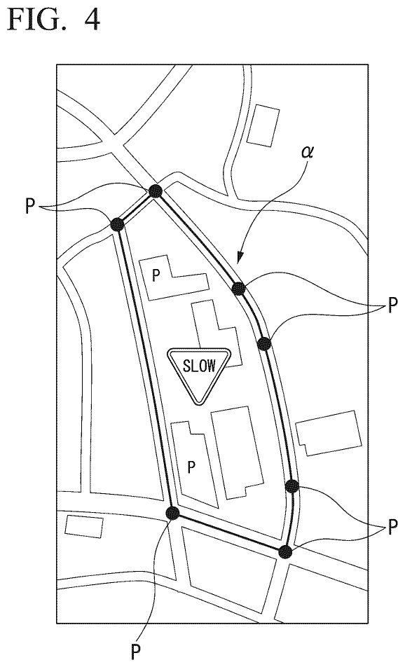

FIG. 4 is a view showing an example of a training-target-area candidate (comparison training-target-area candidates) a set by connecting arbitrary points on a wide road. Since the comparison training-target-area candidate α is set by connecting arbitrary points P on a wide road, it becomes a target of driving evaluation even when the vehicle travels in an adjacent range.

In contrast, the training-target-area candidate 53 set by the setting unit 33 is set by connecting the route along which the vehicle M has actually traveled. For this reason, driving can be evaluated in a range in which a driver actually travels often. The training-target-area candidate 53 may be set by modifying the traveling path along which the vehicle M has actually traveled.

Moreover, as shown in FIG. 3, information related to the driving evaluation item, here, an image showing a sign of “slow down” is displayed on the map together with the training-target-area candidate 53. For this reason, a desired target area that will become a traveling area for which training is requested by a driver and the driving evaluation item identified by the driver are superimposed and displayed on the map of the display unit 40. Therefore, the information displayed by the display unit 40 is simplified so that usability can be improved.

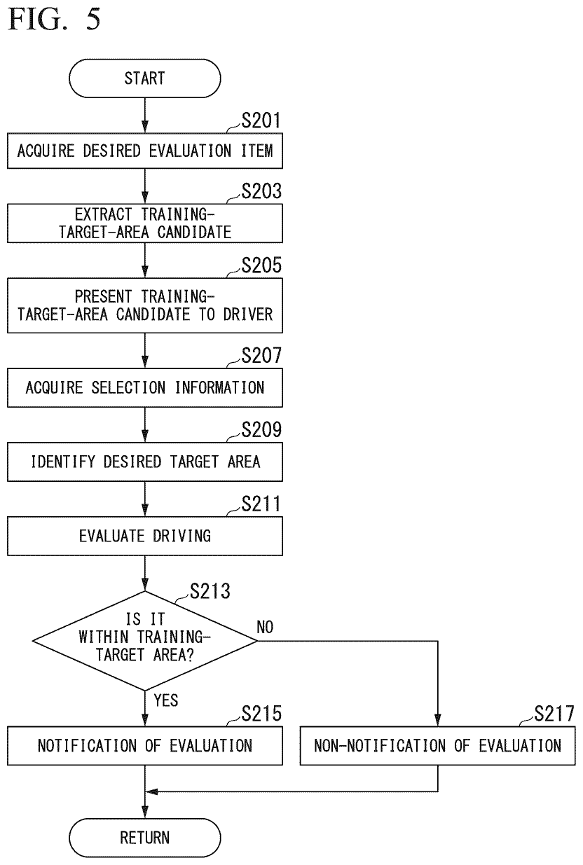

Subsequently, processing of the driving evaluation unit 30 in the driving-behavior evaluation system 1 when driver's training is performed will be described with reference to FIG. 5. FIG. 5 is a flowchart showing an example of processing in the driving evaluation unit 30 of the first embodiment. FIG. 5 shows processing of the driving evaluation unit 30 when driver's training is performed. When the request reception unit 32 of the driving evaluation unit 30 receives a request to start training, the driving-behavior evaluation system 1 operates the terminal device carried by a driver, the input device provided in the vehicle M, or the like to start the processing shown in FIG. 5.

The driving-behavior evaluation system 1 first receives, in the request reception unit 32, the transmitted desired evaluation item together with a request to start training (Step S201). Subsequently, from the training-target-area candidates 53 set by the setting unit 33, the identification unit 34 extracts a plurality of training-target-area candidates or a single training-target-area candidate corresponding to the desired evaluation item (Step S203). Subsequently, the identification unit 34 presents the extracted training-target-area candidate to a driver by displaying it on the display unit 40, or the like (Step S205).

The driver who has been presented with the training-target-area candidate 53 operates the input device, for example, to select a desired target area from among a plurality of training-target-area candidates 53. The input device generates selection information corresponding to the operation of the driver and transmits it to the driving evaluation unit 30. The driving evaluation unit 30 acquires the transmitted selection information in the identification unit 34 (Step S207). The identification unit 34 identifies the desired target area based on the acquired selection information (Step S209).

When the desired target area is identified, the identification unit 34 may present a temporarily identified training-target area to the driver and identify the desired target area after the driver's consent is obtained. The identification unit 34 may present a temporarily identified training-target area to the driver and identify the desired target area after the range of the training-target area is changed by the driver.

After the identification unit 34 has identified the training-target area, the driver causes the vehicle M to travel and starts training. In the driving-behavior evaluation system 1, during traveling of the vehicle M, the external-environment-information acquisition unit 10 acquires the external environment information and the traveling-information acquisition unit 20 acquires the traveling information, thereby transmitting each of them to the driving evaluation unit 30. The driving evaluation unit 30 evaluates, in the evaluation unit 35, driving behavior of the driver based on the external environment information and the traveling information which have been transmitted (Step S211).

The evaluation unit 35 evaluates driving in accordance with the driving evaluation item. For example, when the driving evaluation item is “stop sign”, the evaluation unit 35 identifies, from the map information 51, a position where the vehicle M is required to come to a stop (hereinafter, an evaluation position), such as a position where there is a sign of “stop” or an exit of a narrow road intersecting a wide road. The evaluation unit 35 judges the behavior of the vehicle at the identified evaluation position, here, whether or not the vehicle has come to a stop. The evaluation unit 35 gives high evaluation to the driver when he/she has come to a stop and give low evaluation to the driver when he/she has not come to a stop.

Subsequently, the evaluation unit 35 judges whether or not the evaluation position is within the training-target area (Step S213). When the evaluation unit 35 judges that the evaluation position is within the training-target area, the notification unit 36 notifies the driver of the presence or absence of a violation related to the desired evaluation item, here, a stop sign violation (Step S215). With this, the driving evaluation unit 30 ends the processing shown in FIG. 5.

When the evaluation unit 35 judges that the evaluation position is not within the training-target area, the notification unit 36 does not notify (non-notification) the driver of the presence or absence of a violation related to the desired evaluation item (Step S217). In a case of non-notification of the presence or absence of a violation, the notification unit 36 may notify of non-notification or may notify that the vehicle M is traveling outside the training-target area. In addition, the evaluation unit 35 evaluates the driver in Step S211 regardless of the position of the vehicle M but may evaluate the driver only when the evaluation position is within the training-target area. With this, the driving evaluation unit 30 ends the processing shown in FIG. 5.

The driving-behavior evaluation system 1 of the first embodiment sets a training-target-area candidate for a traveling-target area for training based on the driving evaluation item and the movement history of the driver of the vehicle. Moreover, the driving-behavior evaluation system 1 of the first embodiment receives a request for a driving evaluation item of the driver and identifies a training-target area, for which training is requested, from the training-target-area candidate based on the received driving evaluation item. For this reason, since a user can arbitrarily set the evaluation item and the traveling area as desired, it is possible to evaluate driving by traveling in an area suitable for evaluation. Moreover, it is possible to realize safe driving coaching which is further focused on the points responding to the request of the user.

### Second Embodiment

Subsequently, a second embodiment will be described. The second embodiment is mainly different from the first embodiment in that the driving-behavior evaluation system 2 includes an external server, for example, a driving evaluation server 100 provided outside the vehicle. Moreover, the second embodiment is also different from the first embodiment in that the driving-behavior evaluation system 2 includes a user terminal device 200 carried by a user such as a driver and in that the driving-behavior evaluation system 2 includes a V2X server 300 generally managing vehicle-to-X (V2X) communication. Hereinafter, the second embodiment will be described focusing on points different from the first embodiment. In the following description, the same reference signs are applied to elements common to those in the first embodiment, and description thereof may be omitted.

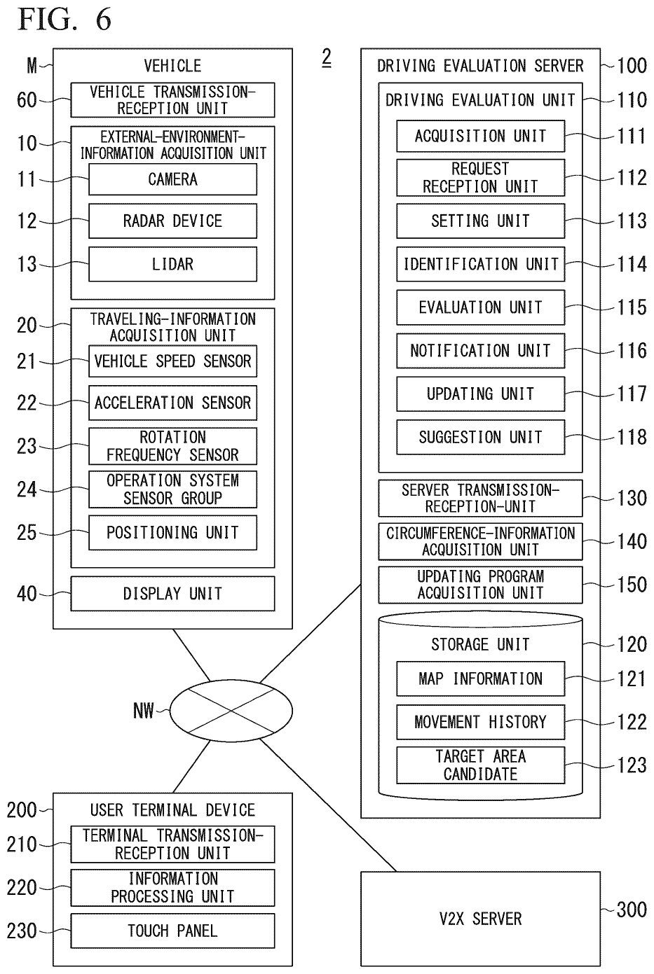

FIG. 6 is a view showing an example of a constitution of the driving-behavior evaluation system 2 of a second embodiment. For example, the driving-behavior evaluation system 2 of the second embodiment includes the vehicle M, the driving evaluation server 100, the user terminal device 200, and the V2X server 300. The vehicle M includes the external-environment-information acquisition unit 10 and the traveling-information acquisition unit 20 similarly to the first embodiment.

In the second embodiment, the vehicle M further includes a vehicle transmission-reception unit 60. The vehicle transmission-reception unit 60 is a device for two-way communication with external devices when viewed from the vehicle M, for example, with the driving evaluation server 100, the user terminal device 200, and the V2X server 300 via a network NW. For example, the vehicle transmission-reception unit 60 is constituted to include a network card, a network interface controller (NIC), and the like. For example, the network NW is constituted to include an intranet, a local area network (LAN), a wireless LAN, and the like.

For example, the driving evaluation server 100 includes a driving evaluation unit 110, a storage unit 120, a server transmission-reception unit 130, a circumference-information acquisition unit 140, and an updating program acquisition unit 150. For example, the driving evaluation unit 110 includes an acquisition unit 111, a request reception unit 112, a setting unit 113, an identification unit 114, an evaluation unit 115, a notification unit 116, an updating unit 117, and a suggestion unit 118.

The server transmission-reception unit 130 is a device for two-way communication with external devices when viewed from the driving evaluation server 100, for example, with the vehicle M, the user terminal device 200, and the V2X server 300 via the network NW. Similar to the vehicle transmission-reception unit 60, for example, the server transmission-reception unit 130 is constituted to include a network card, an NIC, and the like.

The circumference-information acquisition unit 140 acquires circumference information. The circumference information is information obtained from other traffic participants around the vehicle M. For example, the V2X server 300 acquires the circumference information on the vehicle M provided by other vehicles traveling around the vehicle M, transportation facilities other than vehicles, and the like and transmits it to the driving evaluation server 100. The circumference-information acquisition unit 140 acquires the circumference information transmitted from the V2X server 300. In other words, when referring to “vehicles” using ordinal numbers, the vehicle M may be referred to as a first vehicle, and another vehicle traveling around the first vehicle may be referred to as a second vehicle.

For example, the updating program acquisition unit 150 acquires the updated program information transmitted from the V2X server 300. The updating program acquisition unit 150 transmits the acquired updated program information to the updating unit 117 of the driving evaluation unit 110. For example, the updated program information includes information on newly set signs and traffic lights, new roads, and the like.

The acquisition unit 111, the request reception unit 112, the setting unit 113, the identification unit 114, the evaluation unit 115, and the notification unit 116 in the driving evaluation unit 110 have functions similar to those of the acquisition unit 31, the request reception unit 32, the setting unit 33, the identification unit 34, the evaluation unit 35, and the notification unit 36 in the first embodiment. The external environment information and the traveling information acquired by the acquisition unit 111 are information transmitted from the vehicle M. Furthermore, the information, which is displayed in the display unit 40 in the first embodiment, is transmitted to the vehicle M and displayed in the display unit 40 of the vehicle M.

The updating unit 117 acquires the updated program information transmitted from the updating program acquisition unit 150. When the updated program information is acquired, the updating unit 117 inquires of an authority regarding the vehicle M as to whether or not approval related to program updating has been given. For example, the authority may be a driver of the vehicle M, may be an owner of the vehicle M, or may be a passenger of the vehicle M, for example, someone who teaches the driver how to drive. When approval is received from the authority, the updating unit 117 updates the driving evaluation program of evaluating driving behavior of the driver based on the acquired updated program information.

The updating unit 117 may update map information 121 and the like together with the driving evaluation program. The updating unit 117 updates the map information 121 based on the circumference information acquired by the circumference-information acquisition unit 140. The updating unit 117 may be able to update the driving evaluation program based on the updated program information without receiving approval of the authority. In this case, updating information on the outside of the vehicle M which changes over time and the software of a computer device operating the system can be executed appropriately as needed. Therefore, high-value added flexible service can be promoted.

The suggestion unit 118 suggests provision of a predetermined service to the driver based on results of evaluation of the driving behavior by the evaluation unit 115 and a usage history of the driving evaluation unit 110. For example, when the evaluation in the evaluation unit 115 is high, the suggestion unit 118 suggests an offer of an incentive to the driver. For example, the suggestion unit 118 suggests an offer of an incentive via the display unit 40 of the vehicle M or the user terminal device 200 by transmitting offer information related to an offer of an incentive to the display unit 40 of the vehicle M or the user terminal device 200. When the driver has accepted the suggestion, the suggestion unit 118 offers the suggested incentive to the driver. It is possible to improve mindset toward safe driving by offering an incentive to the driver who has achieved high evaluation.

For example, the storage unit 120 stores the map information 121, a movement history 122, and a target area candidate 123. The map information 121, the movement history 122, and the target area candidate 123 are similar to the map information 51, the movement history 52, and the training-target-area candidate 53 in the first embodiment. For example, the movement history 52 is updated based on the external environment information, the traveling information, and the like transmitted from the vehicle M.

The user terminal device 200 is a terminal device carried by a user, for example, a driver. The user terminal device 200 may also be a terminal device carried by an occupant other than the driver of the vehicle M. The terminal device is an example of an information terminal device. For example, the user terminal device 200 is constituted of a smartphone, a tablet, or the like. For example, the user terminal device 200 includes a terminal transmission-reception unit 210, an information processing unit 220, and a touch panel 230. The terminal transmission-reception unit 210 is a device for two-way communication with external devices when viewed from the user terminal device 200, for example, with the vehicle M, the driving evaluation server 100, and the V2X server 300 via the network NW. Similar to the vehicle transmission-reception unit 60, for example, the terminal transmission-reception unit 210 is constituted to include a network card, an NIC, and the like.

The information processing unit 220 generates information corresponding to the operation of the touch panel 230 and transmits the generated information to the external device such as the driving evaluation server 100 or uses it for controlling the user terminal device 200. The touch panel 230 can display a GUI and transmits information corresponding to the operation of the GUI of a user to the information processing unit 220 or displays information and the like transmitted from the driving evaluation server 100. The touch panel 230 is an example of a display unit provided in the user terminal device. Since the usable range of the display unit 40 is expanded to the user terminal device 200 carried by a user in addition to the in-vehicle instrument, review learning after driving has ended can be executed optionally at any place and at any time, and therefore usability is improved. In addition, it is also possible to share the information on learned results with others or utilize the information by using the user terminal device 200.

The V2X server 300 communicates with other vehicles other than the vehicle M and a transportation infrastructure facility related to transportation infrastructure in addition to the vehicle M. For example, the V2X server 300 includes a transmission/reception device similar to the vehicle transmission-reception unit 60, performs V2X related control including the vehicle M and other vehicles as well as various infrastructure facilities, and collects information. For example, the V2X server 300 transmits information which has been generated or acquired in association with V2X to the external device, for example, the driving evaluation server 100.

The driving-behavior evaluation system 2 of the second embodiment exhibits operational effects similar to those of the driving-behavior evaluation system 1 of the first embodiment. In addition, as in the second embodiment, the device for evaluating the driving behavior of a driver may be provided in an external server or the like outside the vehicle M. In addition, the driving-behavior evaluation system 2 of the second embodiment includes the circumference-information acquisition unit 140 acquiring the circumference information of the vehicle M transmitted from the V2X server 300. The evaluation unit 115 evaluates the driving behavior of a driver of the vehicle M further based on the circumference information. For this reason, the driving behavior of a driver can be evaluated more accurately.

Moreover, the driving-behavior evaluation system 2 of the second embodiment acquires an updating program of updating the program of the driving evaluation unit 110 and updates the driving evaluation program using the updating unit 117. For this reason, the driving behavior of a driver can be evaluated more accurately. Moreover, in the driving-behavior evaluation system 2 of the second embodiment, the driving evaluation unit 110 is provided in the driving evaluation server 100 outside the vehicle M. For this reason, not only simplification of in-vehicle resources can be achieved, but also software maintainability such as updating and improvement of the program can be improved. In addition, the server may be a cloud type which simply distributes data or may be an edge computer with high real-time capabilities and data governance. Since the driving evaluation server 100 can be accessed by a plurality of registered users, information on contents of settings between users and evaluation results (violations/model behavior) can be shared or secondary usage can be achieved.

Moreover, the driving-behavior evaluation system 2 of the second embodiment updates the external environment information based on information provided by the V2X server 300 communicating with the vehicle M, other vehicles, and transportation infrastructure facilities. For this reason, traffic rule information, vehicle behavior information, traffic light information, road marking information, and the like acquired by other vehicles are consecutively recorded in the V2X server 300. In the driving-behavior evaluation system 2 of the second embodiment, since these pieces of information are provided to the driving evaluation server 100, the latest information can be updated without imposing a burden on a user even if road conditions or traffic rules change. In addition, since data from other vehicles can be used, it is possible to ascertain in advance violations of laws and regulations which drivers of other vehicles are likely to commit, and therefore users' awareness of safe driving will be cultivated.

Regarding a form based on information on other vehicles, for example, if there is a location where other vehicles often stop, the spot may be set as a stop point. Alternatively, traveling of other vehicles may be recorded and used as normative data for driving. Alternatively, the V2X server 300 may collect positions and behavior of other vehicles and acquire information related to stop lines, stop signs, and speed limits to use them in place of signs.

Moreover, the driving-behavior evaluation system 2 of the second embodiment evaluates driving behavior of a driver based on the circumference information acquired by the circumference-information acquisition unit 140. For this reason, instead of evenly deducting points for sudden operations and violations of laws and regulations and judging the driving as dangerous, driving behavior is evaluated in consideration of objective information from other traffic participants as well. Therefore, for example, when it is judged that the behavior was inevitable to avoid danger, the point-deducted evaluation can be made invalid, and a user can be convinced without feeling uncomfortable. As a result, acceptability of safe driving education can be improved.

In each of the foregoing embodiments, no particular conditions are set for drivers who will become targets for evaluation of driving behavior. However, the targets for evaluation driving behavior may be limited to registered users who have been registered. In this case, for example, the driving evaluation server 100 may include a management unit managing registered-user information related to registered users. The registered users are capable of using the vehicle. In addition, the driving evaluation unit may include an authentication unit authenticating whether a driver entering the vehicle is the registered user. Moreover, the driving evaluation unit may evaluate driving behavior of a driver of the vehicle when the driver is authenticated as the registered user. In this case, it is possible to provide highly convenient services such as pre-registered paid contents.

The embodiment described above can be expressed as follows.

A driving behavior evaluation device includes: a storage medium storing a computer-readable instructions; and a processor connected to the storage medium.

The processor is configured to execute the computer-readable instructions and thereby:
acquire external environment information, the external environment information being related to a circumference environment around a vehicle;
acquire traveling information related to traveling of the vehicle; and
evaluate driving behavior of a driver of the vehicle based on the external environment information and the traveling information which have been acquired.

The processor receives a request for a driving evaluation item of evaluating the driving behavior, sets a training-target-area candidate for a traveling-target area for training based on the driving evaluation item and a movement history of a driver of the vehicle, and identifies a training-target area, for which training is requested, from the set training-target-area candidates based on the received driving evaluation item.

While preferred embodiments of the invention have been described and illustrated above, it should be understood that these are exemplary of the invention and are not to be considered as limiting. Additions, omissions, substitutions, and other modifications can be made without departing from the spirit or scope of the invention. Accordingly, the invention is not to be considered as being limited by the foregoing description, and is only limited by the scope of the appended claims.

What is claimed is:

1. A driving-behavior evaluation system comprising:
an external-environment-information acquisition unit configured to acquire external environment information, the external environment information being related to a circumference environment around a vehicle;
a traveling-information acquisition unit configured to acquire traveling information, the traveling information being related to traveling of the vehicle; and
a processor configured to execute a program and thereby evaluate driving behavior of a driver of the vehicle based on the external environment information acquired by the external-environment-information acquisition unit and the traveling information acquired by the traveling-information acquisition unit, wherein
the processor is configured to:
receive a request for a driving evaluation item of evaluating the driving behavior;
set a training-target-area candidate for a traveling-target area for training based on the driving evaluation item and a movement history of a driver of the vehicle; and
identify a training-target area, for which training is requested, from the set training-target-area candidates based on the driving evaluation item received by the processor.

2. The driving-behavior evaluation system according to claim 1, wherein
when there is a problem related to the driving evaluation item received by the processor regarding the vehicle traveling in the training-target area, the processor issues a notification related to the problem, and
when there is a problem related to an item other than the driving evaluation item received by the processor, the processor does not issue a notification related to the problem.

3. The driving-behavior evaluation system according to claim 1 further comprising:
a display unit configured to display a map including a circumference environment around the vehicle, wherein
the display unit displays the identified training-target area and the driving evaluation item for which a request has been received by the processor.

4. The driving-behavior evaluation system according to claim 1, wherein
the processor is configured to identify the driving evaluation item based on the driving evaluation item received by the processor and external environment information acquired within the set training-target-area candidate.

5. The driving-behavior evaluation system according to claim 3, wherein
the display unit includes at least one of an in-vehicle instrument mounted in the vehicle and an information terminal device carried by an occupant of the vehicle.

6. The driving-behavior evaluation system according to claim 1, wherein
the processor is provided in an external server outside the vehicle.

7. The driving-behavior evaluation system according to claim 6, wherein
the external server is configured to:
communicate with at least one of a different vehicle other than the vehicle and a transportation infrastructure facility related to transportation infrastructure in addition to the vehicle; and
update the external environment information based on at least one of traveling information on the different vehicle and information related to the transportation infrastructure provided by the different vehicle and the transportation infrastructure facility.

8. The driving-behavior evaluation system according to claim 1, wherein
the processor is configured to acquire circumference information obtained from other traffic participants around the vehicle, and
the processor is configured to evaluate driving behavior of a driver of the vehicle further based on the circumference information.

9. The driving-behavior evaluation system according to claim 1, wherein
the processor is configured to acquire an updating program of updating the program,
the program is updated by the updating program acquired by the processor, and
the processor is configured to update the program upon approval by an authority related to the vehicle.

10. The driving-behavior evaluation system according to claim 1, wherein
the processor is configured to suggest provision of a predetermined service to the driver based on results of evaluation of driving behavior from the processor and a usage history of the processor.

11. The driving-behavior evaluation system according to claim 6, wherein
the external server is configured to manage registered-user information related to a registered user,
the registered user is capable of using the vehicle,
the processor is configured to authenticate whether a driver entering the vehicle is the registered user, and
the processor is configured to evaluate driving behavior of the driver of the vehicle when the driver is authenticated as the registered user.

12. A driving-behavior evaluation method causing a computer to:
acquire external environment information, the external environment information being related to a circumference environment around a vehicle;
acquire traveling information, the traveling information being related to traveling of the vehicle; and
evaluate driving behavior of a driver of the vehicle based on the external environment information and the traveling information which have been acquired, wherein
the computer
receives a request for a driving evaluation item of evaluating the driving behavior,
sets a training-target-area candidate for a traveling-target area for training based on the driving evaluation item and a movement history of a driver of the vehicle, and
identifies a training-target area, for which training is requested, from the set training-target-area candidates based on the received driving evaluation item.

13. A computer-readable non-transitory storage medium storing a program, the program causing a computer to:
acquire external environment information, the external environment information being related to a circumference environment around a vehicle;
acquire traveling information, the traveling information being related to traveling of the vehicle; and
evaluate driving behavior of a driver of the vehicle based on the external environment information and the traveling information which have been acquired, wherein
the computer
receives a request for a driving evaluation item of evaluating the driving behavior,
sets a training-target-area candidate for a traveling-target area for training based on the driving evaluation item and a movement history of a driver of the vehicle, and
identifies a training-target area, for which training is requested, from the set training-target-area candidates based on the received driving evaluation item.
